(19) United States
(12) Patent Application Publication
(10) Pub. No.: US 2016/0221792 A1
(43) Pub. Date: Aug. 4, 2016

(54) Locking device for elevator car

(71) Applicant: Chiu Nan Wang, Taichung (TW)

(72) Inventor: Chiu Nan Wang, Taichung (TW)

(21) Appl. No.: 15/093,692

(22) Filed: Apr. 7, 2016

(51) Int. Cl. B66B 5/00; E05C 1/08

(52) U.S. Cl. CPC B66B 5/00; E05C 1/08

(57) ABSTRACT

A locking device for the cab of an elevator includes two sets of locking members disposed on two sides of the cab respectively, each locking member including a spring-biased retractable lock pin extending out of either side of the cab; and two sets of plate members disposed on two opposite surfaces of a shaft respectively, each plate member including a hole aligned with the lock pin. The locking members co-act with a door of the cab. The lock pin either extends into the hole for locking the door of the cab when the door of the cab is open or removes out of the hole for unlocking the door of the cab when the door of the cab is closed.

### BACKGROUND OF THE INVENTION

1. Field of the Invention

The invention relates to elevator safety devices and more particularly to a locking device including locking members each having a spring biased lock pin adapted to insert into a hole of a plate member mounted on a surface of a shaft when the door of a cab of an elevator is open or retract when the door is closed.

2. Description of Related Art

A cab of an elevator may slip after being locked after arriving at a desired floor. This is because, after a long period of time of use, there is wear of the hoist ropes, low adhesive friction between the hoist ropes and the drive sheave, overload of the car, etc.

Thus, the need for improvement of the locking device for an elevator still exists.

### SUMMARY OF THE INVENTION

It is therefore one object of the invention to provide a locking device comprising two sets of a plurality of locking members disposed on two sides of a cab of an elevator respectively, each locking member including a spring-biased retractable lock pin extending out of either side of the cab; and two sets of a plurality of plate members disposed on two opposite surfaces of a shaft respectively, each plate member including a hole aligned with the lock pin; wherein the locking members co-act with a door of the cab; and wherein the lock pin is configured to either extend into the hole for locking the door of the cab when the door of the cab is open or remove out of the hole for unlocking the door of the cab when the door of the cab is closed.

The above and other objects, features and advantages of the invention will become apparent from the following detailed description taken with the accompanying drawings.

### BRIEF DESCRIPTION OF THE DRAWINGS

FIG. 1 is a perspective view of the cab of an elevator incorporating a locking device according to a first preferred embodiment of the invention;

FIG. 2 is a side view in part section showing the unlocked locking member when the cab door is closed;

FIG. 3 is a view similar to FIG. 2 showing the locked locking member when the cab door is open;

FIG. 4 is a view similar to FIG. 3 showing the lock pin (i.e., the car) prevented from moving further upward when contacts an upper end of the hole;

FIG. 5 is a view similar to FIG. 3 showing the lock pin (i.e., the car) prevented from moving further downward when contacts a lower end of the hole; and

FIG. 6 is a perspective view of an elevator incorporating a locking device according to a second preferred embodiment of the invention.

### DETAILED DESCRIPTION OF THE INVENTION

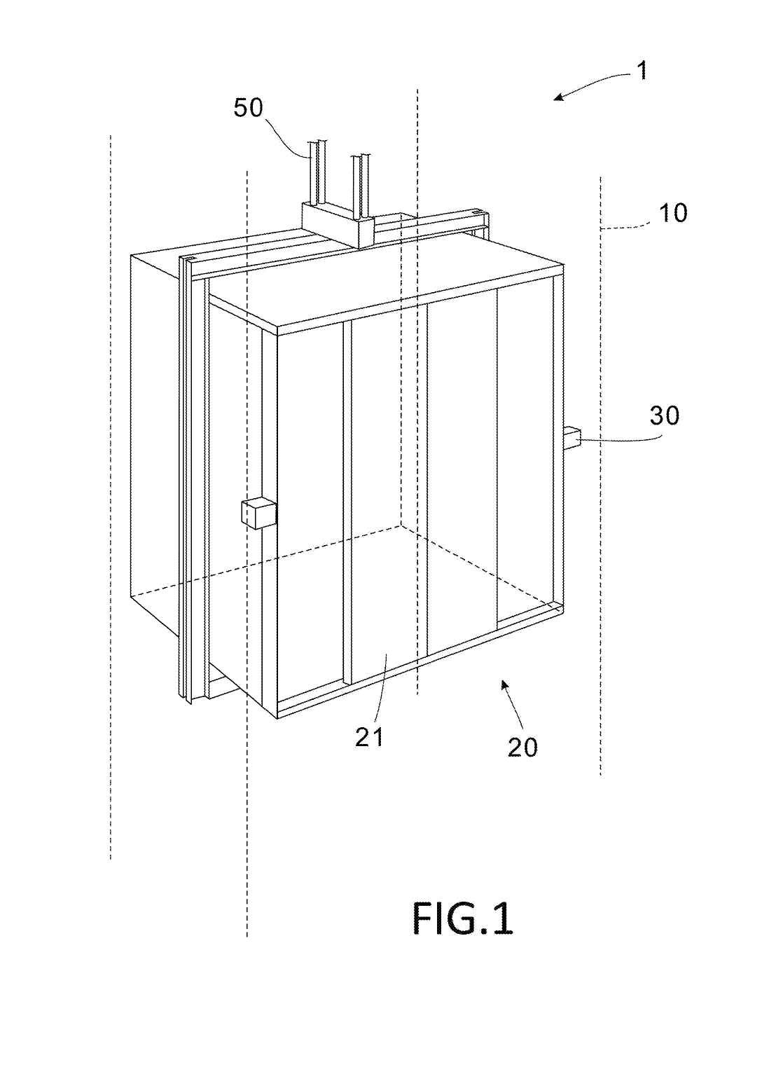

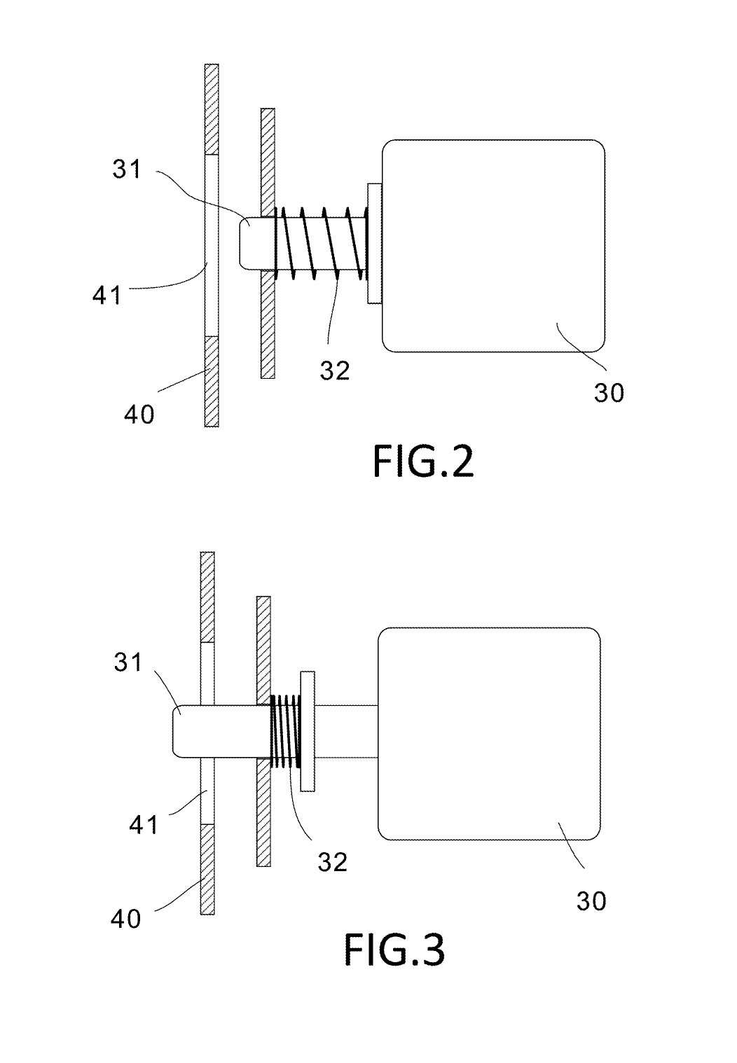

Referring to FIGS. 1 to 5, a locking device for a cab 20 of an elevator 1 installed in a shaft 10 in accordance with a first preferred embodiment of the invention is shown and discussed in detail below.

The cab 20 is hoisted by hoist ropes 50 and includes a door 21. The locking device includes two locking members 30 provided on two sides of the cab 20 respectively. The locking member 30 includes a retractable lock pin 31 extending out of one side, and a torsion spring 32 put on the lock pin 31. Two plate members 40 are provided on two opposite surfaces of the shaft 10 at each floor respectively. The plate member 40 includes a hole 41 aligned with the lock pin 31.

The locking member 30 co-acts with the door 21. In detail, the lock pin 31 may extend into the hole 41 for locking the door 21 when the door 21 is open and the lock pin 31 may remove out of the hole 41 for unlocking the door 21 when the door 21 is closed.

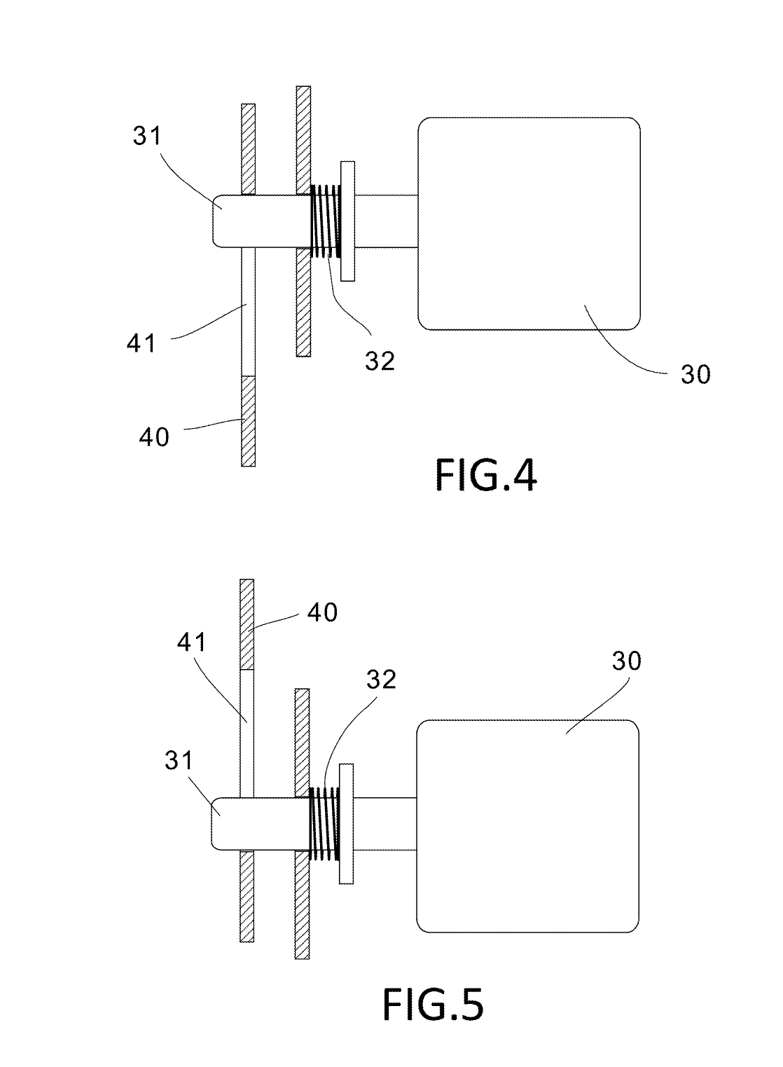

As shown in FIGS. 4 and 5, the hole 41 is greatly larger than the forward end of the lock pin 31 so that an allowance between the hole 41 and the lock pin 31 is planned.

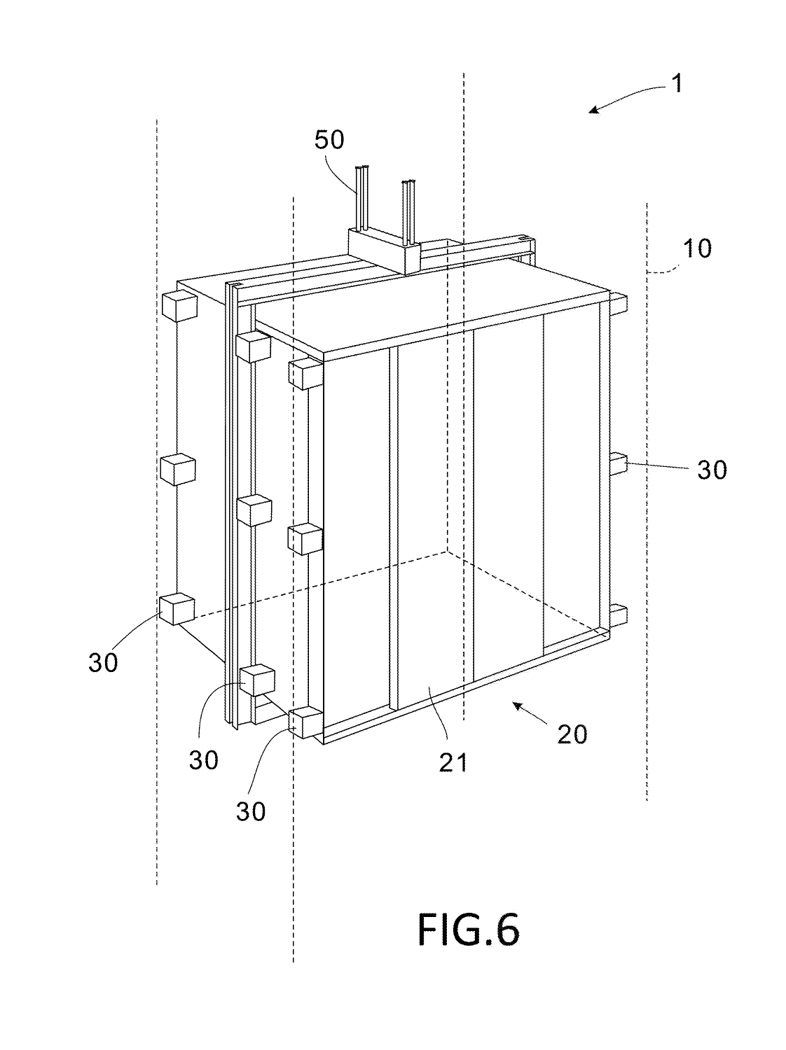

Referring to FIG. 6, a locking device for a cab 20 of an elevator 1 installed in a shaft 10 in accordance with a second preferred embodiment of the invention is shown. The characteristics of the second preferred embodiment are substantially the same as that of the first preferred embodiment except the following:

A plurality of locking members 30 are provided on two sides of the cab 20 respectively.

While the invention has been described in terms of preferred embodiments, those skilled in the art will recognize that the invention can be practiced with modifications within the spirit and scope of the appended claims.

What is claimed is:

1. A locking device comprising:
two sets of a plurality of locking members disposed on two sides of a cab of an elevator respectively, each locking member including a spring-biased retractable lock pin extending out of either side of the cab; and
two sets of a plurality of plate members disposed on two opposite surfaces of a shaft respectively, each plate member including a hole aligned with the lock pin;
wherein the locking members co-act with a door of the cab; and
wherein the lock pin is configured to either extend into the hole for locking the door of the cab when the door of the cab is open or remove out of the hole for unlocking the door of the cab when the door of the cab is closed.
